(19) United States
(12) Patent Application Publication
(10) Pub. No.: US 2022/0094383 A1
(43) Pub. Date: Mar. 24, 2022

(54) PROTECTIVE CASE WITH A FORCE BUFFERING FUNCTION

(71) Applicant: SHENZHEN LANHE TECHNOLOGIES CO., LTD., Shenzhen (CN)

(72) Inventors: SHUAI ZHANG, Shenzhen (CN); ZE-WU ZHANG, Shenzhen (CN); JIA-CHUN YANG, Shenzhen (CN); QING HAN, Shenzhen (CN)

(21) Appl. No.: 17/482,784

(22) Filed: Sep. 23, 2021

(30) Foreign Application Priority Data
Sep. 23, 2020 (CN) 202022114983.5
Dec. 28, 2020 (CN) 202023233280.0
Jan. 16, 2021 (CN) 202120119222.0
Feb. 8, 2021 (CN) 202120367406.9
Mar. 3, 2021 (CN) 202120463795.5
May 20, 2021 (CN) 202121093612.1
Jul. 8, 2021 (CN) 202121548444.0
Aug. 27, 2021 (CN) 202122052138.4

(51) Int. Cl. H04B 1/3888; A45C 11/00

(52) U.S. Cl. CPC H04B 1/3888; A45C 2011/002; A45C 11/00

(57) ABSTRACT

The present disclosure provides a protective case with a force buffering function. The protective case includes a case body and at least one sealed airbag on the case body. The case body includes an accommodating cavity. Each of the at least one sealed airbag includes a sealed case and an airbag chamber in the sealed case.

### CROSS REFERENCE TO RELATED APPLICATIONS

This application claims the benefit of priority of Chinese Application No. 202022114983.5 filed on Sep. 23, 2020, Chinese Application No. 202120463795.5 filed on Mar. 3, 2021, Chinese Application No. 202121093612.1 filed on May 20, 2021, Chinese Application No. 202120119222.0 filed on Jan. 16, 2021, Chinese Application No. 202023233280.0 filed on Dec. 28, 2020, Chinese Application No. 202120367406.9 filed on Feb. 8, 2021, Chinese Application No. 202122052138.4 filed on Aug. 27, 2021, and Chinese Application No. 202121548444.0 filed on Jul. 8, 2021, the contents of which are incorporated by reference herein.

### FIELD

The present disclosure generally relates to electronic device accessories, in particular to a protective case with a force buffering function.

### BACKGROUND

With continuous improvements of quality of mobile phones, users' demand for mobile phone protection is also increasing. Screens and cases of electronic devices such as mobile phones are fragile and susceptible to damage when dropped, which may cause the electronic devices unavailable.

A conventional protective case for a mobile phone generally includes a frame including four corners, and the four corners and an inner surface of the frame are provided with a plurality of grooves to achieve a force buffering effect. By setting the plurality of grooves, when the protective case is mounted to the mobile phone, the mobile phone is adjacent to openings of the plurality of grooves, and a space is formed between inner circumferential walls of the plurality of grooves and the mobile phone, thereby achieving the force buffering effect. However, the force buffering effect is not ideal.

### BRIEF DESCRIPTION OF THE DRAWINGS

Implementations of the present technology will now be described, by way of example only, with reference to the attached figure, wherein:

FIG. 1 is a perspective view of a protective case with a force buffering function of a first embodiment.

FIG. 2 is a perspective view of the protective case with a force buffering function of FIG. 1 but viewed from another angle.

FIG. 3 is an exploded view of the protective case with a force buffering function of FIG. 1.

FIG. 4 is an exploded view of a protective case with a force buffering function of a first modified embodiment of the first embodiment.

FIG. 5 is a perspective view of a protective case with a force buffering function in a second modified embodiment of the first embodiment.

FIG. 6 is an exploded view of the protective case with a force buffering function of FIG. 5.

FIG. 7A is a perspective view of a sealed airbag of the first embodiment.

FIG. 7B is a cross-sectional view of the sealed airbag of FIG. 7A.

FIG. 8 is a perspective view of a protective case with a force buffering function of a second embodiment.

FIG. 9 is an exploded view of sealed airbags disengaged from the protective case of FIG. 8.

FIG. 10 is a cross-sectional view of the protective case of FIG. 8.

FIG. 11 is an enlarged view of circled portion A of FIG. 10.

FIG. 12 is a perspective view of a sealed airbag of FIG. 9.

FIG. 13 is an exploded view of a sealed airbag of FIG. 12.

FIG. 14 is an exploded view of the sealed airbag of FIG. 12 but viewed from another angle.

FIG. 15 is a perspective view of a protective case of FIG. 8 but viewed from another angle.

FIG. 16 is a cross-sectional view of the protective case of FIG. 15.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” when utilized, means “including, but not necessarily limited to”; it specifically indicates open-ended inclusion or membership in the so-described combination, group, series and the like. In particular, when describing “a certain element”, the present disclosure does not limit the number of the element to one, and it may include more than one element.

A first aspect of the present disclosure provides a protective case with a force buffering function, comprising: a case body provided with an accommodating cavity for accommodating an electronic device; and at least one sealed airbag on the case body, each of the at least one sealed airbag comprising a sealed case and an airbag chamber in the sealed case, the airbag chamber being filled with a buffer medium.

The case body is made of soft material.

The buffer medium comprises gas and/or liquid.

The at least one sealed airbag comprises a plurality of sealed airbags spaced apart on the case body.

The at least one sealed airbag is detachably on the case body.

The case body comprises a back plate and a frame surrounding the back plate, the back plate and the frame form the accommodating cavity, the at least one sealed airbag is on the back plate and/or the frame.

The at least one sealed airbag is on the frame, at least one groove is on an inner surface and/or an outer surface of the frame, the at least one sealed airbag is in the at least one groove; or at least one notch is on the frame, the at least one sealed airbag is in the at least one notch; or at least one through hole is on the frame, the at least one sealed airbag is in the at least one through hole.

The at least one sealed airbag is on the back plate, at least one groove is on an inner surface and/or an outer surface of the back plate, the at least one sealed airbag is in the at least one groove; or at least one notch is on the back plate, the at least one sealed airbag is in the at least one notch; or at least one through hole is on the back plate, the at least one sealed airbag is in the at least one through hole.

The at least one sealed airbag is fixed in the at least one groove and/or the notch and/or the through hole by pasting, snapping, or embedding.

An outer surface away from the airbag chamber is flush with an inner surface of the frame or the back plate; or an outer surface away from the airbag chamber protrudes from an inner surface of the frame or the back plate.

A second aspect of the present disclosure provides a protective case with a force buffering function, comprising: a case body with an accommodating cavity and an installation groove, the accommodating cavity being configured to accommodate an electronic device; and at least one sealed airbag comprising a force buffering means fixed in the installation groove and comprising a cavity, a first flange protruding from the force buffering means, a blocking means at least partially inserted into the cavity and form the airbag chamber with the force buffering means, and a second flange protruding from the blocking means and connected to the first flange.

The installation groove is in communication with the accommodating cavity, the blocking means comprises a first convex portion and a second convex portion, the first convex portion is inserted into the cavity, the second convex portion extends from the first convex portion to a direction away from the cavity, the first convex portion and the force buffering means form the airbag chamber, a side of the second convex portion away from the first convex portion is flush with an inner wall of the accommodating cavity, and the second flange is on an outer side of the second convex portion.

An outer surface of the first convex portion is in contact with an inner surface of the cavity.

The installation groove is in communication with an outer side of the sealed case, the at least one airbag at least partially protrude to the outer side of the sealed case.

The inner wall of the installation groove is recessed to form a limiting groove, a distance is between the limiting groove and both the inner surface and the outer surface of the case body, and the first flange and the second flange are fixed in the limiting groove.

The first flange and the second flange are fixed in the limiting groove by injection molding.

The first flange is ring-shaped and surrounds the force buffering means; and/or the second flange is ring-shaped and surrounds the blocking means.

The first flange and the second flange are attached and fixed by a hot-melting process.

The airbag chamber is filled with a buffer medium comprising a plurality of elastic particles.

The force buffer means is made of transparent material, the plurality of elastic particles comprises at least two kinds of colors; and/or the blocking means is provided with a recessed portion for receiving the plurality of elastic particles.

Embodiment 1

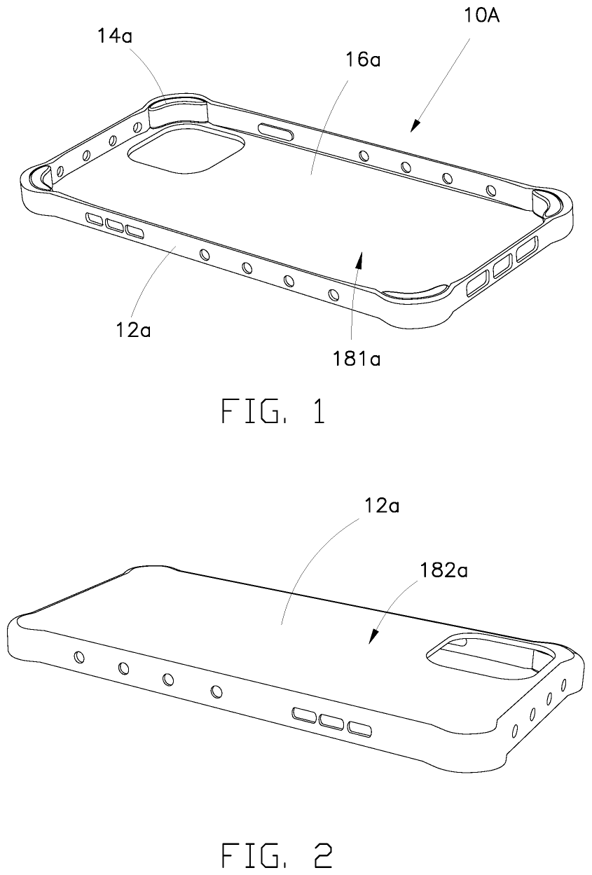

As shown in FIG. 1 through FIG. 6, a protective case 10A with a force buffering function in a first embodiment can be used to cover an electronic device for protection. The electronic device can be a mobile phone, a tablet computer, etc.; and this embodiment takes a mobile phone as an example for specific description. The protective case 10A comprises a case body 12a and a plurality of sealed airbags 14a. The case body 12a is provided with an accommodating cavity 16a for accommodating a mobile phone, and the sealed airbags 14a are attached to the case body 12a for providing a force buffering effect and protection for the mobile phone received in the case body 12a when the mobile phone drops. In this embodiment, the sealed airbags 14a are directly attached to the case body 12a without using any additional element for connecting the sealed airbags 14a and the case body 12a, and the sealed airbags 14a are in directly contact with the case body 12a.

In this embodiment, the case body 12a is a half-wrapped structure and includes a back plate 18a and a frame 20a connected to and surrounding a periphery of the back plate 18a. The back plate 18a and the frame 20a enclose the accommodating space 16a. The back plate 18a may be made of polycarbonate (PC) material; and the frame 20a may be made of thermoplastic polyurethanes (TPU) material, for example. A hardness of the back plate 18a is different from a hardness of the frame 20a. Namely, the frame 20a is softer than the back plate 18a. The sealed airbags 14a may be provided on the case body 12a in a manner of spaced apart from each other. For example, the sealed airbags 14a may be in the back plate 18a, and/or the sealed airbags 14a may be in the frame 20a, and/or the sealed airbag 14a may be on a surface of the back plate 18a (such as an inner surface 181a and/or an outer surface 182a), and/or the sealed airbags 14a may be on a surface of the frame 20a (for example, an inner surface 201a near the accommodating cavity 16a and/or an outer surface 202a away from the accommodating cavity 16a).

In other embodiments, the case body 12a may also be designed as other structures. For example, the case body 12a may be a frame structure, wherein the sealed airbags 14a may be on an inner wall of the case body 12a. The case body 12a can also be an all-enclosed structure, wherein the sealed airbags 14a can be on all inner walls of the all-enclosed case body 12a or only on one or more inner walls of the all-enclosed case body 12a, which can realize an all-round or a local protection for the mobile phone.

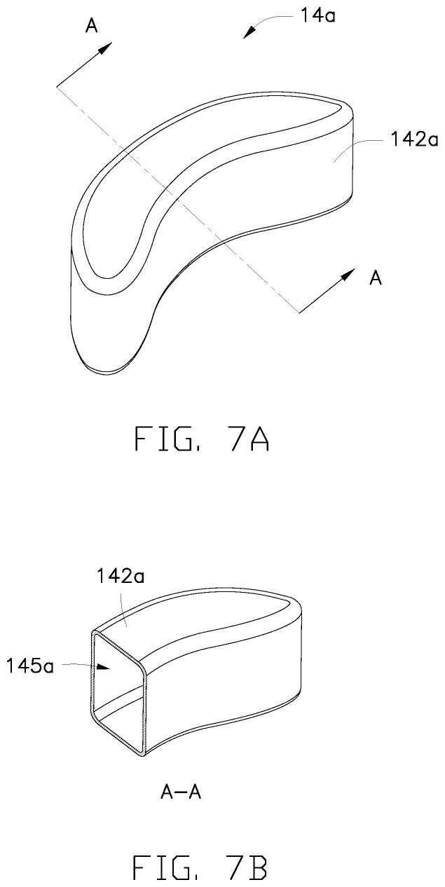

Each of the sealed airbags 14a have a compressible deformation function. As shown in FIG. 7A and FIG. 7B, each of the sealed airbags 14a comprises a sealed case 142a and a sealed chamber 145a in the sealed case 142a. The sealed chamber 145a is filled with a buffer medium, so that each of the sealed airbags 14a has an elastic buffering function. The buffer medium may be a fluid such as gas and/or liquid, and the gas is air, for example. The sealed case 142a may be made of soft materials, so that when it is dropped or collided, a compressibility of the air or the fluidity of the liquid inside the enclosed airbags 14a can be used to achieve an elastic buffering effect, which has a good drop protection function.

Since each of the sealed airbags 14a is a sealed structure, if any of the sealed airbag 14a is damaged during use, a cushion and a protection performance of the sealed airbag 14a which is damaged will lost. In order to solve this problem, a connection between the sealed airbags 14a and the case body 12a is a detachable connection. Therefore, when any of the sealed airbags 14a is damaged, the user can replace the sealed airbag 14a damaged, thereby ensuring the protective case 10a a good drop protection performance, bringing convenience to users.

The case body 12a is substantially rectangular. Considering four corners of the mobile phone first collide with the ground when the mobile phone is dropped, four sealed airbags 14a are respectively provided at four corners 21a of the frame 20a in the first embodiment. Since four corners of the mobile phone are designed in an arcuate shape, the four corners 21a of the frame 20a are arcuately shaped to match with the mobile phone.

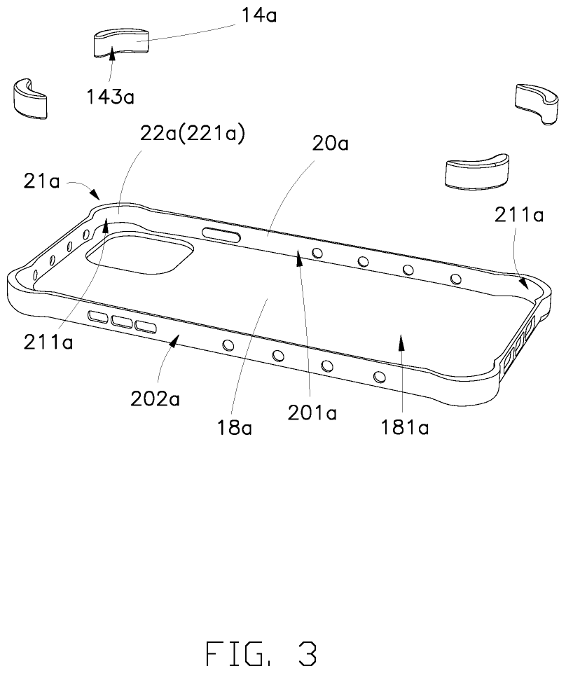

More specifically, referring to FIG. 3, each of the four corners 21a of the frame 20a has an arcuated shape and protrude outwards, so that a groove 22a is formed at an inner side 211a of each of the four corners 21a and in air communication with the accommodating space 16a, and the groove 22a has an arcuate shape. Correspondingly, each of the sealed airbags 14a is designed to be an arcuate shape adapted to the shape of the groove 22a, so that the sealed airbag 14a can just fit in the groove 22a.

Furthermore, when the sealed airbags 14a are mounted in the grooves 22a, an inner surface 143a of the sealed case 142a facing the accommodating cavity 16a has a shape adapted with the four corners of the mobile phone, so that when the mobile phone is received in the accommodating space 16a, the four corners of the mobile phone contacts and fits the inner surface 143a of the sealed case 142a to create a better protection for the mobile phone. The inner surface 143a of the sealed case 142a can be designed to form a continuous smooth surface together with the inner surface 201a of the frame 20a, that is, both ends of the inner surface 143a of the sealed case 142a are flush with or smoothly transit to the inner surface 201a of the frame 20a, so that when the mobile phone is placed in the case body 12a, the sealed airbags 14a can be close to and in contact with the mobile phone. Alternatively, the inner surface 143a of each of the sealed case 142a exposed to the accommodating cavity 16a may be concaved relative to the inner surface 201a of the frame 20a, wherein when the mobile phone is received in the case body 12a, the sealed airbags 14a do not contact the mobile phone, which is conducive to force buffering. The inner surface 143a of the sealed case 142a can also be designed to slightly protrude from the inner surface 201a of the frame 20a. When the mobile phone is placed in the case body 12a, the sealed airbags 14a are squeezed by the mobile phone in a slightly compressed state, so that the protective case 10A can also play a protective effect against slight collision in daily use.

In other embodiments, the groove 22a may be on the inner surface 181a and/or the outer surface 182a of the back plate 18a, and/or on the inner surface 201a and/or the outer surface 202a of the frame 20a among the four corners 21a, which is conducive to protecting multiple parts of the mobile phone when the mobile phone is dropped.

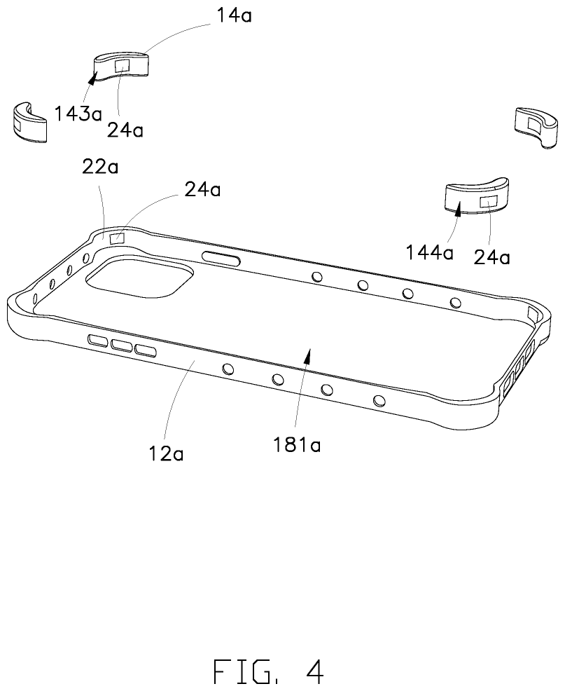

Each of the sealed airbags 14a can be detachably fixed in the groove 22a by adhering, snapping using latching structures, or embedding. The term “embedding” in the present disclosure means directly connected to without using any additional element, such as adhesive, or connecting member, and a proper manner of “embedding” comprises overmolding. Referring to FIGS. 1 through 3, each of the sealed airbags 14a is embedded in the groove 22a, that is, each of the sealed airbags 14a is directly connected to a groove wall of one of the grooves 22a without using any additional element to connect the sealed airbags 14a and the case body 12a. In a first modified embodiment shown in FIG. 4, each of the sealed airbags 14a is fixed in the groove 22a by adhering. For example, an outer surface 144a of the sealed airbag 14a and a groove wall 221a of the groove 22a are respectively provided with a sticking portion 24a. The sticking portion 24a may be a sticking layer with adhesive. In the first embodiment, the sticking portion 24a is also provided on the inner surface 143a of the sealed airbag 14a, and the sticking portion 24a on the inner surface 143a of the sealed airbag 14a is configured to stick the mobile phone, so that the mobile phone is stably sleeved in the case body 12a.

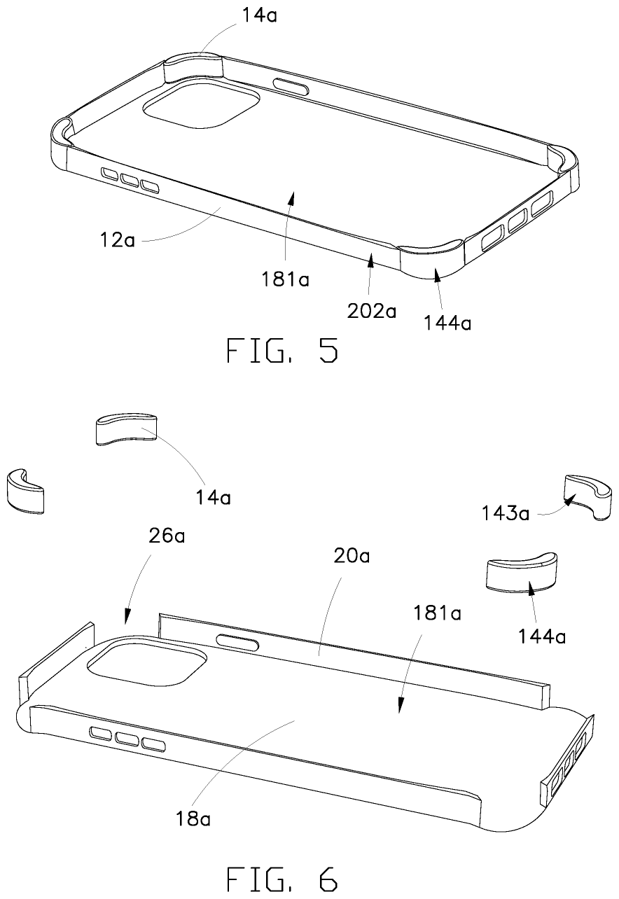

Referring to FIG. 5 and FIG. 6, in a second modified embodiment of the first embodiment, each of the four corners 21a of the frame 20a is provided with one notches 26a. A shape of the notches 26a is adapted to the sealed airbags 14a. Each of the sealed airbags 14a can be detachably fixed in the notches 26a by adhering, snapping, or embedding. In the present embodiment, each of the sealed airbags 14a is embedded in one of the notches 26a.

Further, when the sealed airbags 14a are fixed in the notches 26a, a shape of the inner surface 143a of the sealed case 142a is fitted to the four corners of the mobile phone, so that when the mobile phone is installed in the accommodating cavity 16a, each of the four corners of the mobile phone fits the inner surface 143a of one of the sealed cases 142a is conducive to protecting the mobile phone. The inner surface 1421a of the sealed case 142a and the inner surface 201a of the frame 20a form a continuous smooth surface together. That is, both ends of the inner surface 143a of the sealed case 142a are flush with the inner surface 201a of the frame 20a or smoothly transit to the inner surface 201a of the frame 20a, so that the sealed airbags 14a can be close to the mobile phone when the mobile phone is in the case body 12a. The inner surface 143a of the sealed case 142a can also protrude from the inner surface 201a of the frame 20a.

The sealed airbags 14a are squeezed by the mobile phone in a slightly compressed state when the mobile phone is in the case body 12a, so that the protective case 10A can protect the mobile phone from slight collision.

In the second modified embodiment, the outer surface 144a of the sealed case 142a and the outer surface 202a of the frame 20a may form a continuous smooth surface. That is, both ends of the outer surface 144a of the sealed case 142a are flush with or smoothly transited to the outer surface 202a of the frame 20a, so that an aesthetics of the protective case 10A may be enhanced. Alternatively, the outer surface 144a of the sealed case 142a can slightly protrude from the outer surface 202a of the frame 20a, which can better protect the mobile phone and the protective case 10A when the mobile phone is dropped.

In other embodiments, the notches 26a may also be provided in the back plate 18a, and/or in the frame 20a among the four corners 21a, which can achieve a force buffering protection for multiple parts of the mobile phone.

In other embodiments, the four corners 21a of the frame 20a may be recessed inward to form a groove on the outer surface 202a of the frame 20a, wherein each of the sealed airbags 14a is in the groove. In this case, a designation of a transition between the outer surface 144a of the sealed case 142a and the outer surface 202a of the frame 20a can refer to the embodiment shown in FIG. 5 and FIG. 6, which will not be repeated here. The four corners of the frame 20a may be provided with through holes, and the sealed airbags 14a are in the through holes. In this case, a designation of a transition between the outer surface 144a of the sealed case 142a and the outer surface 202a of the frame 20a can refer to the embodiment shown in FIG. 5 and FIG. 6, which will not be repeated here. The above-mentioned embodiment only takes the sealed airbags 14a on the four corners of the frame 20a as an example, and the corresponding structures are also applicable to situations that the sealed airbags 14a are on other positions of the frame 20a or on the back plate 18a.

In the present embodiment, a plurality of avoidance openings, through holes, thickened portions, and notches are formed on the case body 12a corresponding to microphones, speakers, charging interfaces, switch buttons, volume buttons, and cameras of the mobile phone, so that various functions of the mobile phone can be normally performed after the case body 12a is covered on the mobile phone. The thickened portions are integrally formed with the case body 12a.

The protective case with a force buffering function of the first embodiment can enhance the force buffering effect by the sealed airbags on the case and filling the buffering medium (gas or liquid) in the sealed case of each of the sealed airbags. The sealed case can be made of soft materials, when a collision occurs, the compressibility of the gas or the fluidity of the liquid inside the sealed airbags can be used to achieve an elastic buffering effect, which has a good force buffering effect. The sealed airbags can be at the four corners of the case body, or on the back plate and the frame of the case body, which can realize a force buffering protection for multiple parts of the mobile phone. The sealed airbags and the case body can be detachably connected, so the users can replace the sealed airbags to ensure the force buffering effect of the protective case, which brings convenience to the users.

Embodiment 2

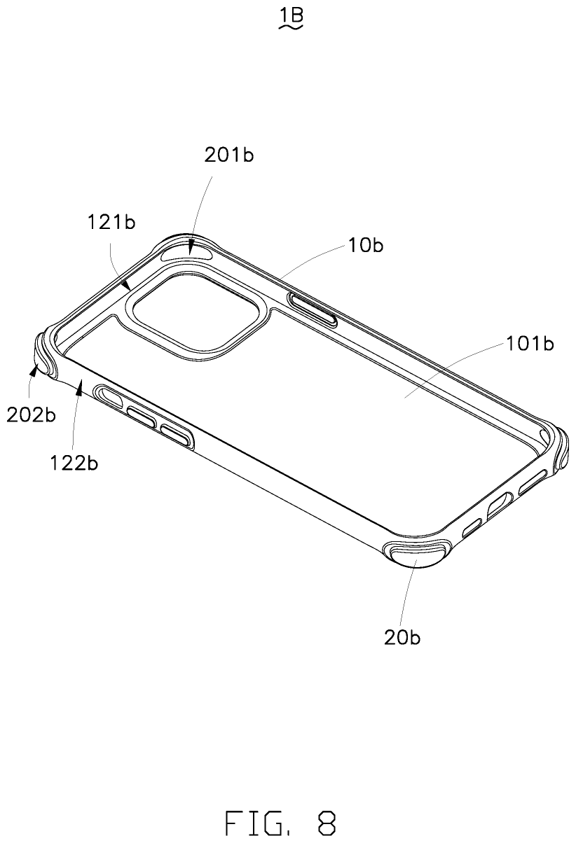

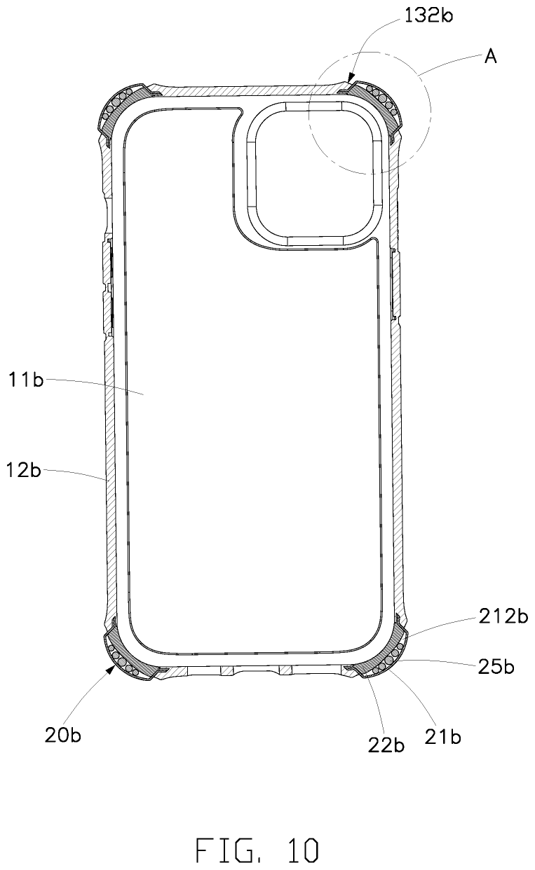

Referring to FIG. 8 through FIG. 10, a second embodiment of the present disclosure provides a protective case 1B with a force buffering function. The protective case 1B comprises a case body 10b and at least one sealed airbag 20b. The case body 10b is provided with an accommodating cavity 101b and at least one installation groove 102b. The accommodating cavity 101b is configured to receive an electronic device such as a mobile phone and a tablet. Each of the sealed airbag 20b is fixed in one of the installation grooves 102b. In this embodiment, the protective case 1B comprises four sealed airbags 20b, the case body 10b is provided with four installation grooves 102b, and the electronic device is a mobile phone. Each of the sealed airbags 20b has a compressible deformation function, thereby a force buffering effect is achieved. If the mobile phone covered with the protective case 1B falls from a high altitude or is impacted by an external force, each of the sealed airbags 20b can absorb and decompose an impact force to achieve the force buffering effect. As a result, the mobile phone in the accommodating cavity 101b is prevented from being damaged.

The case body 10b comprises a back plate 11b and a frame 12b surrounding an edge of the back plate 11b, wherein the frame 12b and the back plate 11b are enclosed to form the accommodating cavity 101b. The frame 12b is preferably made of TPU (thermoplastic polyurethane elastomer rubber) soft rubber, and the back plate 11b is preferably made of transparent PC (polycarbonate) hard rubber. A hardness of the back plate 11b is different from a hardness of the frame 1 2b. Namely, the frame 12b is softer than the back plate 11b.

In this embodiment, the frame 12b is substantially rectangular and comprises four corners 120b. Each of the installation grooves 102b is at one of the four corners 120b of the frame 12b, that is, each of the sealed airbags 20b is at one of the corners 120b of the frame 12b, which may enhance the force buffering effect of the protective case 1B at the corners 120b. Specifically, each of the corners 120b of the frame 12b is provided with one of the installation grooves 102b and one of the sealed airbags 20b.

In a modified embodiment of the second embodiment, each of the installation grooves 102b may be in other parts of the frame 12b or the back plate 11b. That is, each of the sealed airbags 20b may be in other parts of the frame 12b or the back plate 11b.

The frame 12b has an arcuated shape at the corners 120b and each of the sealed airbags 20b has a substantially arcuated shape. A thickness of the frame 12b at the corners 120b is greater than that in other parts of the frame 12b, which may enhance the buffering effect at the corners 120b of the protective case 1B.

In other embodiments, the installation grooves 102b may be formed at an inner side 105b of the case body 10b to be in air communication with the accommodating cavity 101b, formed at an outer side 104b of the case body 10b to be spaced from the accommodating cavity 101b, or directly penetrate the case body 10b to make the accommodating cavity 101b be in air communication with the outside of the case body 10b. In this embodiment, the inner side 105b is a side of the case body 10b closed to the accommodating cavity 101b, and the outer side 104b is a side of the case body 10b away from the accommodating cavity 101b.

In this embodiment, the installation grooves 102b penetrate the frame 12b of the case body 10b, thereby communicating the accommodating cavity 101b with the outside of the frame 12b. An inner side 201b of each of the sealed airbags 20b is a side close to the accommodating cavity 101b and is flush with an inner surface 121b of the frame 12b. So that the protective case 1B can be completely covered on the outside of the mobile phone.

An outer side 202b of each of the sealed airbags 20b is away from the accommodating cavity 101b and protrudes from an outer surface 122b of the frame 12b away from the accommodating cavity 101b or is flush with the outer surface 122b of the frame 12b. Preferably, each of the sealed airbags 20b protrudes from the outer surface 122b of the frame 12b, wherein when the protective case 1B falls laterally, each of the sealed airbags 20b first contacts the ground and absorbs parts of the impact force, thereby achieving the buffering effect.

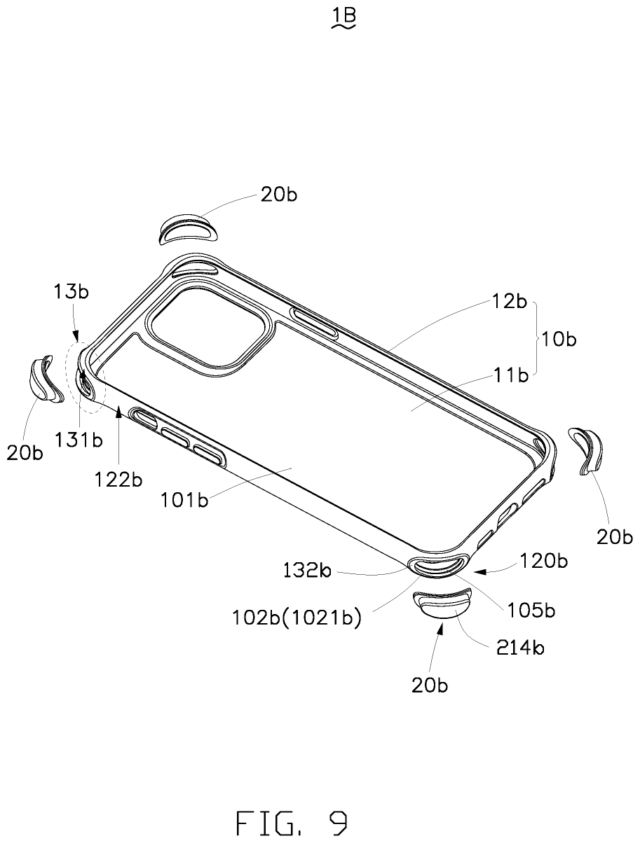

Referring to FIG. 9 through FIG. 11, each of the sealed airbags 20b includes a force buffering means 21b and a blocking means 22b. The force buffer means 21b is fixed to one of the installation grooves 102b by injection molding. A side of the force buffering means 21b away from the accommodating cavity 101b protrudes from the outer surface 122b of the frame 12b, and a side of the blocking means 22b closed to the accommodating cavity 101b is flush with the inner surface 121b of the frame 12b.

Both the force buffering means 21b and the blocking means 22b are preferably made of TPU (Thermoplastic Polyurethane Elastomer Rubber) to ensure that each of the sealed airbags 20b has good elasticity, that is, to ensure that each of the sealed airbag 20b has a good buffering effect.

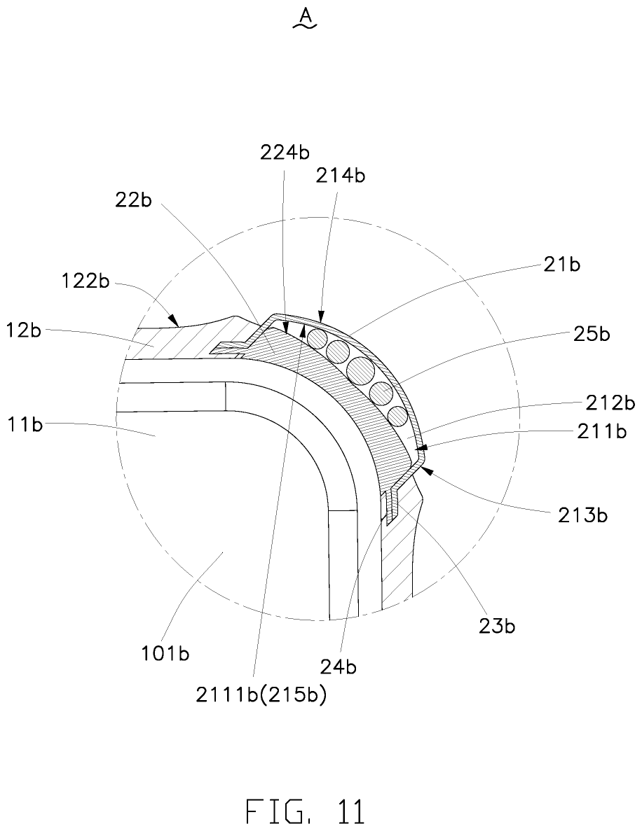

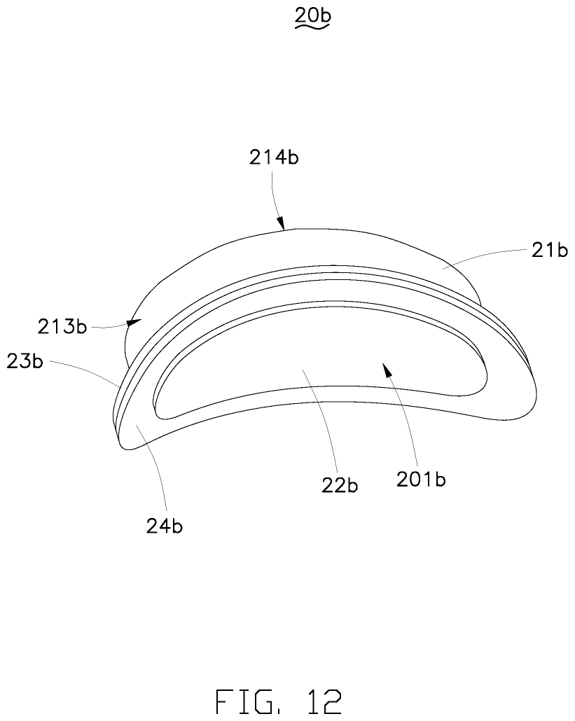

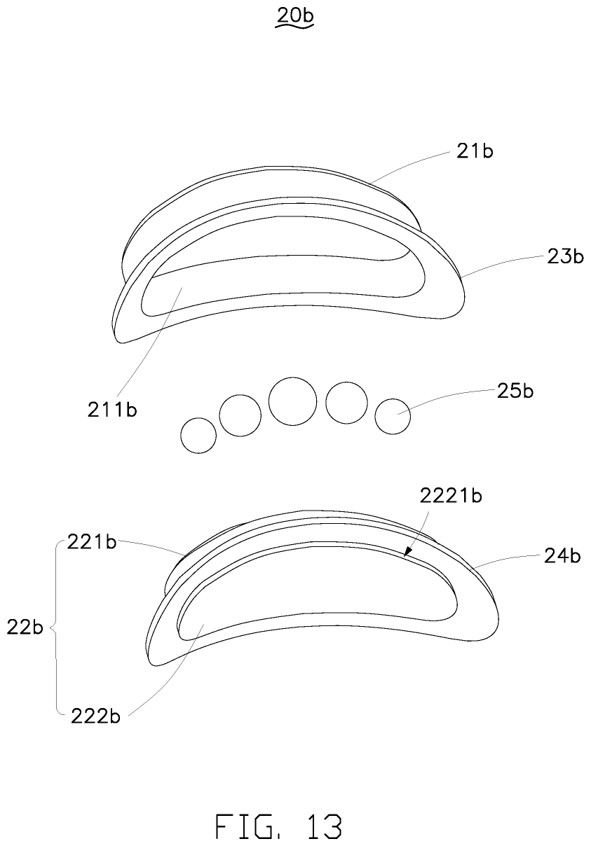

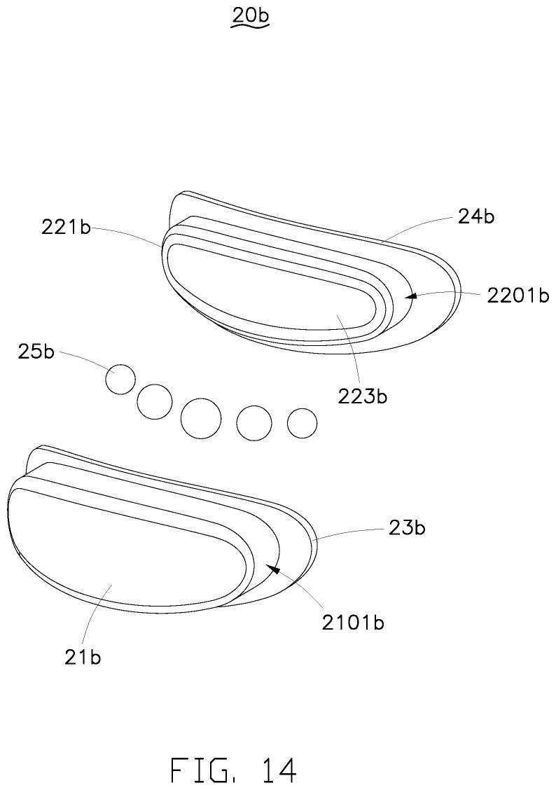

Referring to FIG. 11 through FIG. 14, a cavity 211b is on a side of the force buffering means 21b closed to the accommodating cavity 101b, and the blocking means 22b is at least partially inserted into the cavity 211b and cooperates with the force buffering means 21b to form an airbag chamber 212b. When the force buffering means 21b is fixed to the installation groove 102b by injection molding, the part of the blocking means 22b inserted into the cavity 211b may bear a squeezing force caused by injection molding to prevent the squeezing force from squeezing the sealed airbags 20b.

An outer wall of the blocking means 22b and an inner wall 2111b of the cavity 211b may be attached to each other or may be separated by a distance.

An outer side 2101b of the force buffering means 21b is provided with a first flange 23b, and an outer side 220 lb of the blocking means 22b is provided with a second flange 24b. Both the first flange 23b and the second flange 24b are fixed to the frame 12b, and the first flange 23b and the second flange 24b are mutually attached and fixed. In this embodiment, the first flange 23b and the second flange 24b are fixed together by hot-melting process, and the hot-melting process includes a high-frequency process or an ultrasonic process. Both the first flange 23b and the second flange 24b are protruding structures that bulge outwards, so that the sealed airbags 20b will not be damaged during the hot-melting process.

The blocking means 22b includes a first convex portion 221b and a second convex portion 222b, the first convex portion 221b is inserted into the cavity 211b and cooperates with the force buffering means 21b to form the airbag chamber 212b, the second convex portion 222b extends from the first convex portion 221b in a direction away from the cavity 211b, the first convex portion 221b and the force buffering means 21b cooperate to form the airbag chamber 212b, and a side of the second convex portion 222b away from the first convex portion 221b is exposed to the accommodating cavity 101b, wherein a hardness of the blocking means 22b is greater than a hardness of the force buffering means 21b.

The airbag chamber 212b protrudes at least partially from the frame 12b. Preferably, the entire airbag chamber 212b protrudes from the outer surface 122b of the frame 12b, so that the airbag chamber 212b may withstand a great impact to maximize the force buffering effect of the sealed airbags 20b. The second convex portion 222b is fixed on a side of the first convex portion 221b closed to the accommodating cavity 101b. The second convex portion 222b extends in a direction away from the cavity 211b to be flush with the inner wall 1011b of the accommodating cavity 101b. The second flange 24b is on an outer side 222 lb of the second convex portion 222b.

The force buffering means 21b and the first flange 23b are preferably integrally formed, and the first convex portion 221b, the second convex portion 222b, and the second flange 24b are preferably integrally formed, which is conducive to enhance a strength of the protective case 1B and reduce an assembling process.

In this embodiment, the first flange 23b and the second flange 24b are both ring-shaped, the first flange 23b surrounds the force buffering means 21b, and the second flange 24b surrounds the second convex portion 222b of the blocking means 22b. The airbag chamber 212b can be formed by fixing the first flange 23b ring-shaped and the second flange 24b ring-shaped by hot-melting.

The frame 12b is further provided with four limiting grooves 105b. Each of the limiting grooves 105b is recessed and formed on an inner wall 1021b of one of the installation grooves 102b facing one of the sealed airbags 20b. The first flange 23b and the second flange 24b of each of the sealed airbags 20b are both fixed in one of the limiting grooves 105b.

Preferably, each of the limiting grooves 105b is in the middle of one of the installation grooves 102b. That is, there is a distance between each of the limiting grooves 105b and both the inner surface 121b and the outer surface 122b of the frame 12b, which may increase a contact area between each of the sealed airbags 20b and the frame 12b and helps to strengthen a connection of each of the sealed airbags 20b and the frame 12b.

In this embodiment, after the first flange 23b and the second flange 24b are fixed together by hot-melting, the first flange 23b and the second flange 24b of each of the sealed airbags 20b are fixed in one of the limiting grooves 105b through injection molding, so that each of the sealed airbag 20b is firmly fixed to the case body 10b.

Referring to FIG. 11 through FIG. 14, the airbag chamber 212b of each of the sealed airbags 20b is provided with a buffer medium 25b. A type of the buffer medium 25b is not limited. For example, when the airbag chamber 212b is sealed, the buffer medium 25b may be air, liquid, or solid with elasticity. When the airbag chamber 212b is not sealed, the buffer medium 25b may be solid with elasticity.

In this embodiment, the buffer medium 25b includes a plurality of elastic particles in the airbag chamber 212b. The elastic particles are between the force buffering means 21b and the blocking means 22b. Preferably, the elastic particles are made of deformable material, such as PTE (polyethylene terephthalate) soft rubber to ensure that the elastic particles have good elasticity and have a good buffering effect.

Shapes of the elastic particles are not limited. For example, the elastic particles may be spherical or columnar. In this embodiment, the elastic particles are elastic balls.

The elastic particles include at least two different colors. The force buffering means 21b is made of transparent material, wherein the elastic particles inside the sealed airbags 20b can be observed through the force buffering means 21b, which may enhance an aesthetics of the protective case 1B.

A recessed portion 223b is provided in the middle of a side of the blocking means 22b away from the accommodating cavity 101b, wherein the elastic particles are partially contained in the recessed portion 223b. The recessed portion 223b not only enlarged a space of the airbag chamber 212b, but also limited the elastic particles to the middle of the airbag chamber 212b.

In at least one embodiment, one ring-shaped protuberance 13b is formed at each of the four corners 120b, the ring-shaped protuberance 13b surrounds the corresponding sealed airbag 20b. At least a portion of the ring-shaped protuberance 13b protrudes from the outer surface 122b of the frame 12b. That is, at least a portion of the ring-shaped protuberance 13b extends outward and beyond the outer surface 122b of the frame 12b. In at least one embodiment, the ring-shaped protuberance 13b protrudes from a top surface 131b away from the back plate 11b and the outer surface 122b of the frame 12b.

In at least one embodiment, the sealed airbags 20b are exposed from the outer surface 122b of the frame 12b.

In at least one embodiment, a portion of each of the sealed airbags 20b exposed from the outer surface 122b of the frame 12b is directly exposed to an external space and has a continuous surface. That is, the portions of each of the sealed airbags 20b exposed from the outer surface 122b of the frame 12b is not covered by any other elements.

In at least one embodiment, the portion of each of the sealed airbags 20b exposed from the outer surface 122b of the frame 12b has a substantially elliptical shape.

In at least one embodiment, the portion of each of the sealed airbags 20b exposed from the outer surface 122b of the frame 12b has a top surface 214b away from the accommodating cavity 101b and a side surface 213b connected to and surrounding the top surface 214b, the top surface 213b has an arcuated shape, and a first projection of the top surface 214b on a plane parallel to the back plate 11b is a curve segment. The protuberance 13b comprises a top surface 132b away from the accommodating cavity 101b. A second projection of the top surface 132b on a plane parallel to the back plate 11b has a same shape with the first projection of the top surface 214b, and the second projection of the top surface 132b and the first projection of the top surface 214b do not overlap with each other.

The back plate 11b is provided with a camera escape hole 113b and a camera protection frame 114b surrounding the camera escape hole 113b, and the camera protection frame 114b protrudes from an outer surface 112b of the back plate 11b.

The force buffering means 21b comprises a top wall 215b facing the accommodating cavity 101b, the first convex portion 221b comprises a top surface 224b facing the top wall 215b of the force buffering means 21b. A maximum distance between the top surface 224b of the first convex portion 221b and a top wall 215b of the force buffering means 21b is 0.5-6.0 mm. The top surface 224b exposed to the cavity 211b, and the top wall 215b facing the top surface 224b.

The top surface 224b of the first convex portion 221b protrudes from a top surface 132b of the protuberance 13b.

The outer surface 122b of the frame 12b is a curved surface, and the inner surface 121b of the frame 12b is a plane.

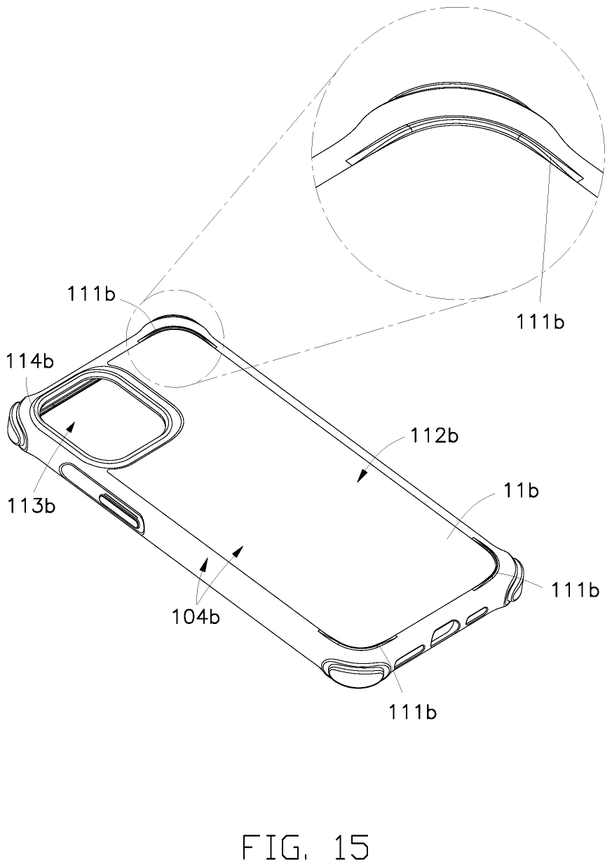

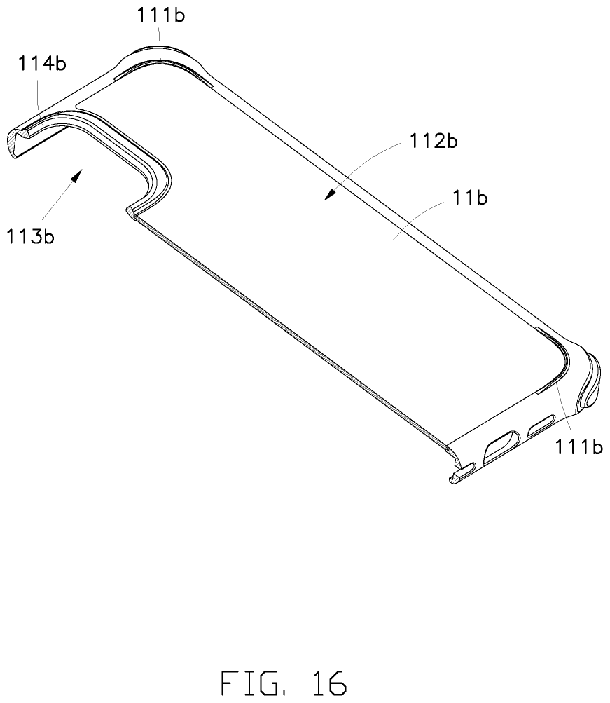

As shown in FIG. 15 and FIG. 16, in other embodiments, the case body 10b is provided with at least one protruding strip 111b protruding from a surface of the back plate 11b. The protruding strip 111b is configured to compensate a height difference between the camera protection frame and the outer surface 112b of the back plate 11b. In this case, a stability of the protective case 1B may be enhanced, that is, the protective case 1B will not shake when the protective case 1B is placed on a plane.

The protective case with a force buffering function of this embodiment includes the sealed airbags, when the protective case falls from a high place or is impacted by an external force, the sealed airbags can achieve a buffering function and absorb an impact force, which makes the protective case having the force buffering function. The blocking means at least partially inserts into the cavity of the force buffering means, when the force buffering means is fixed to the installation groove by an injection molding process, a portion of the blocking means inserted into the cavity can withstand a squeezing force generated during the injection molding process, which avoids squeezing and damaging the sealed airbags. Both the first flange and the second flange are protruding structures that protrude outward, which facilitates the sealed airbags not to be damaged when fixing the force buffering means and the blocking means by hot-melting process.

The embodiments shown and described above are only examples. Many details are often found in the art such as the other features of a server. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A protective case with a force buffering function, comprising:
a case body comprising an accommodating cavity;
at least one sealed airbag on the case body, each of the at least one sealed airbag comprising a sealed case and an airbag chamber in the sealed case.

2. The protective case with a force buffering function of claim 1, wherein the at least one sealed airbag is directly attached to the case body without any element for connecting the at least one sealed airbag and the case body.

3. The protective case with a force buffering function of claim 1, wherein the case body is substantially rectangular and comprises a back plate and a frame surrounding the back plate, the at least one sealed airbag is on at least four corners of the frame.

4. The protective case with a force buffering function of claim 3, wherein one ring-shaped protuberance is on each of the four corners, the frame comprises an outer surface away from the accommodating cavity, and the ring-shaped protuberance surrounds the at least one sealed airbag and at least a portion of the ring-shaped protuberance protrudes from the outer surface of the frame.

5. The protective case with a force buffering function of claim 4, wherein the protuberance comprises a top surface away from the accommodating cavity;
the frame comprises an outer surface away from the accommodating cavity, a portion of the at least one sealed airbag exposed to the outer surface of the frame has a top surface away from the accommodating cavity; and
a first projection of the top surface of the at least one sealed airbag is on a plane parallel to the back plate, a second projection of the top surface of the protuberance is on the plane parallel to the back plate, the first projection and the second projection have a same shape, and the first projection and the second projection do not overlap.

6. The protective case with a force buffering function of claim 3, wherein the at least one sealed airbag is exposed to the accommodating cavity.

7. The protective case with a force buffering function of claim 6, wherein a surface of each of the at least one sealed airbag exposed to the accommodating cavity and an inner surface of the frame near the accommodating cavity transit smoothly; or
the surface of each of the at least one sealed airbag exposed to the accommodating cavity is concaved relative to the inner surface of the frame.

8. The protective case with a force buffering function of claim 6, wherein the frame comprises an outer surface away from the accommodating cavity and the at least one sealed airbag is exposed to the outer surface of the frame.

9. The protective case with a force buffering function of claim 8, wherein a portion of each of the at least one sealed airbag exposed from the outer surface of the frame is directly exposed to an external space and has a continuous surface.

10. The protective case with a force buffering function of claim 8, wherein a portion of the at least one sealed airbag exposed to the outer surface of the frame has a substantially elliptical shape.

11. The protective case with a force buffering function of claim 10, wherein the portion of the at least one sealed airbag exposed to the outer surface of the frame has a top surface away from the accommodating cavity and a side surface connected to and surrounding the top surface, the top surface of the portion has an arcuated shape, and a first projection of the top surface on a plane parallel to the back plate is a curve segment.

12. The protective case with a force buffering function of claim 3, wherein the back plate is provided with a camera escape hole and a camera protection frame surrounding the camera escape hole, and the camera protection frame protrudes from an outer surface of the back plate away from the accommodating cavity.

13. The protective case with a force buffering function of claim 3, wherein the at least one sealed airbag is transparent.

14. The protective case with a force buffering function of claim 3, wherein the airbag chamber is filled with a buffer medium selected one or more from a group consisting of air, liquid, and elastic particles.

15. The protective case with a force buffering function of claim 3, wherein a hardness of the back plate is different from a hardness of the frame.

16. The protective case with a force buffering function of claim 3, wherein the case body is provided with at least one protruding strip protruding from a surface of the back plate away from the accommodating cavity.

17. The protective case with a force buffering function of claim 1, wherein the case body is further provided with a plurality of installation grooves, each of the at least one sealed airbag is fixed in one of the plurality of installation grooves; and
each of the at least one sealed airbag comprises a force buffering means and a blocking means, the force buffering means comprises a cavity, and the blocking means and the force buffering means cooperate to form the airbag chamber.

18. The protective case with a force buffering function of claim 17, wherein a first flange is protruding from the force buffering means, the blocking means is at least partially inserted into the cavity, and the blocking means is provided with a second flange fixed to the first flange, an inner wall of each of the plurality of installation grooves facing the at least one sealed airbag is recessed to form a limiting groove, a distance is between the limiting groove and both an inner surface of the frame near the accommodating cavity and an outer surface of the frame away from the accommodating cavity, and the first flange and the second flange are fixed in the limiting groove.

19. The protective case with a force buffering function of claim 18, wherein the blocking means comprises a first convex portion inserted into the cavity and a second convex portion extending from the first convex portion in a direction away from the cavity, the first convex portion and the force buffering means cooperate to form the airbag chamber, and a side of the second convex portion away from the first convex portion is exposed to the accommodating cavity.

20. The protective case with a force buffering function of claim 19, wherein the force buffering means comprises a top wall facing the accommodating cavity, the first convex portion comprises a top surface facing the top wall of the force buffering means, a maximum distance between the top surface of the first convex portion and the top wall of the force buffering means is 0.5-6.0 mm.
